(19) United States
(12) Patent Application Publication
(10) Pub. No.: US 2022/0156958 A1
(43) Pub. Date: May 19, 2022

(54) MOVING IMAGE DISTANCE CALCULATOR AND COMPUTER-READABLE STORAGE MEDIUM STORING MOVING IMAGE DISTANCE CALCULATION PROGRAM

(71) Applicant: Ryuichi OKA, Tsukuba-shi (JP)

(72) Inventor: Ryuichi OKA, Tsukuba-shi (JP)

(21) Appl. No.: 17/427,915

(22) PCT Filed: Mar. 27, 2019
(86) PCT No.: PCT/JP2019/013289

§ 371 Date: Aug. 3, 2021

(30) Foreign Application Priority Data
Feb. 22, 2019 (JP) 2019-030904
Mar. 7, 2019 (JP) 2019-041980

(51) Int. Cl. G06T 7/579; G06T 7/215; G06T 7/11; G06T 7/269

(52) U.S. Cl. CPC G06T 7/579; G06T 7/215; G06T 2207/10016; G06T 7/269; G06T 7/11

(57) ABSTRACT

A moving image distance calculator (100) includes an optical flow extractor (104a) that extracts the optical flows of M objects in an image at time t of moving images captured by a camera (200), an optical flow value calculator (104b) that calculates the magnitudes of the optical flows as values qₘ (m=1, 2, . . . , M), and a distance calculator (104c) that calculates the distances Zₘ (m=1, 2, . . . , M) from the M objects to the camera (200) by Zₘ=a·exp(bqₘ) where a and b are constants and are calculated by a=Z_{L}·exp((μ/(γ−μ))log(Z_{L}/Z_{N})) and b=(1/(μ−γ))log(Z_{L}/Z_{N}) where μ and γ are the smallest value and the largest value, respectively, of the values qₘ of the optical flows and Z_{N} and Z_{L} are the closest distance and the farthest distance, respectively, of the distances from the M objects to the camera (200).

### TECHNICAL FIELD

The present invention relates to a moving image distance calculator and a computer-readable storage medium storing a moving image distance calculation program. More specifically, the present invention relates to a moving image distance calculator and a computer-readable storage medium storing a moving image distance calculation program that use moving images of objects captured by a camera to calculate the distances from the objects in the moving images to the camera.

### BACKGROUND ART

In recent years, a camera for capturing images of the outside world has often been mounted on a moving object, such as a vehicle or drone. Also, there has recently been a demand to not only simply capture images of the state of the outside world using a camera but also obtain the distances to objects surrounding the camera available for autonomous driving of a vehicle or the like on the basis of captured moving images.

There have been proposed methods including capturing moving images of objects using a camera and calculating the distances from the objects to the camera on the basis of the captured moving images (for example, see Patent Literature 1 and 2). Hereafter, a method proposed in Patent Literature 1 is referred to as the “AMP (accumulated-motion-parallax) method,” and a method proposed in Patent Literature 2 as “the FMP (frontward-motion-parallax) method.”

The AMP method is a method of using moving images of objects captured by a camera moving in the lateral direction to calculate the distances from the objects to the camera. The FMP method is a method of using moving images of objects captured by a camera moving forward or rearward to calculate the distances from the objects to the camera. Both the AMP method and FMP method use moving images of objects captured by one camera to calculate the distances from the objects to the camera.

### CITATION LIST

### Patent Literature

PTL1: Japanese Unexamined Patent Application Publication No. 2018-40789
PTL2: Japanese Patent Application No. 2017-235198

### SUMMARY OF INVENTION

### Technical Problem

However, the AMP method, which is characterized to include using moving images of objects captured by a camera moving in the lateral direction to calculate the distances to the objects, has difficulty in using moving images of objects captured by a camera not moving in the lateral direction to obtain the distances to the objects. Also, to calculate the distances from objects to a camera using the AMP method, the objects have to be stationary. For this reason, if objects in captured moving images are moving objects, this method has difficulty in obtaining the distances from the objects to the camera.

The FMP method, which is characterized to include using moving images of objects captured by a camera moving forward or rearward to calculate the distances from the objects to the camera, has difficulty in using moving images of objects captured by a camera moving in the lateral direction or a camera moving in an oblique direction to obtain the distances from the objects to the camera.

The present invention has been made in view of the above problems, and an object thereof is to provide a moving image distance calculator and a computer-readable storage medium storing a moving image distance calculation program that are able to use moving images of objects captured by a camera to calculate the distances from the objects to the camera, regardless of the moving state or moving direction of the camera.

### Solution to Problem

To solve the above-mentioned problems, a moving image distance calculator according to one aspect of the present invention includes: an optical flow extractor configured to use moving images of M objects captured by a camera to extract M optical flows from pixels corresponding to the M objects in an image at time t of the moving images, M being equal to or greater than 3; an optical flow value calculator configured to calculate magnitudes of the M optical flows extracted by the optical flow extractor as values qₘ of the M optical flows, m being an integer of 1 to M; and a distance calculator configured to calculate distances Zₘ from the M objects to the camera by the formula, in being an integer of 1 to M: Zₘ=a·exp(bqₘ) wherein a and b are constants and are calculated by a=Z_{L}·exp((μ/(γ−μ)) log(Z_{L}/Z_{N})) and b=(1/(μ−γ))log(Z_{L}/Z_{N}) where μ and γ are the smallest value and the largest value, respectively, of the values qₘ of the M optical flows calculated by the optical flow value calculator and Z_{N} and Z_{L} are the closest distance and the farthest distance, respectively, of the distances from the M objects to the camera and are previously measured.

A computer-readable storage medium storing moving image distance calculation program according to another aspect of the present invention that uses moving images of M objects captured by a camera to calculate distances from the M objects in the moving images to the camera. M is equal to or greater than 3. The moving image distance calculation program causes a computer to perform: an optical flow extraction function of extracting M optical flows from pixels corresponding to the M objects in an image at time t of the moving images; an optical flow value calculation function of calculating magnitudes of the M optical flows extracted by the optical flow extraction function as values qₘ of the M optical flows, m being an integer of 1 to M; and a distance calculation function of calculating distances Zₘ from the M objects to the camera by the formula, m being an integer of 1 to M: Zₘ=a·exp(bqₘ) wherein a and b are constants and are calculated by a=Z_{L}·exp((μ/(γ−μ))log(Z_{L}/Z_{N})) and b=(1/(μ−γ))log(Z_{L}/Z_{N}) where μ and γ are the smallest value and the largest value, respectively, of the values qₘ of the M optical flows calculated by the optical flow value calculation function and Z_{N} and Z_{L} are the closest distance and the farthest distance, respectively, of the distances from the M objects to the camera and are previously measured.

A moving image distance calculator according to yet another aspect of the present invention includes: an all pixel optical flow extractor configured to use moving images of M objects captured by a camera to extract optical flows of all pixels of an image at time t of the moving images, M being equal to or greater than 3; an all pixel optical flow value calculator configured to calculate magnitudes of the optical flows of all the pixels extracted by the all pixel optical flow extractor as values of the optical flows of all the pixels; a region segmenter configured to segment the image at time t into K regions by applying a mean-shift method to the image at time t, K being equal to or greater than M; a region-specific optical flow value calculator configured to calculate values qₘ of optical flows corresponding to the M objects by extracting M regions including pixels of the image at time t on which the objects are seen, from the K regions segmented by the region segmenter and obtaining an average of values of optical flows of all pixels in each of the M regions, m being an integer of 1 to M; and a distance calculator configured to calculate distances Zₘ from the M objects to the camera by the formula, m being an integer of 1 to M: Zₘ=exp(bqₘ) wherein a and b are constants and are calculated by a=Z_{L}·exp((μ/(γ−μ))log(Z_{L}/Z_{N})) and b=(1/(μ−γ))log(Z_{L}/Z_{N}) where μ and γ are the smallest value and the largest value, respectively, of the values qₘ of the M optical flows calculated by the region-specific optical flow value calculator and Z_{N} and Z_{L} are the closest distance and the farthest distance, respectively, of the distances from the M objects to the camera and are previously measured.

A computer-readable storage medium storing moving image distance calculation program according to still yet another aspect of the present invention that uses moving images of M objects captured by a camera to calculate distances from the M objects in the moving images to the camera. M is equal to or greater than 3. The moving image distance calculation program causes a computer to perform: an all pixel optical flow extraction function of extracting optical flows of all pixels of an image at time t of the moving images; an all pixel optical flow value calculation function of calculating magnitudes of the optical flows of all the pixels extracted by the all pixel optical flow extraction function as values of the optical flows of all the pixels; a region segmentation function of segmenting the image at time t into K regions by applying a mean-shift method to the image at time t, K being equal to or greater than M; a region-specific optical flow value calculation function of calculating values qₘ of optical flows corresponding to the M objects by extracting M regions including pixels of the image at time t on which the objects are seen, from the K regions segmented by the region segmentation function and obtaining an average of values of optical flows of all pixels in each of the M regions, m being an integer of 1 to M; and a distance calculation function of calculating distances Zₘ from the M objects to the camera by the formula, m being an integer of 1 to M: Zₘ=a·exp(bqₘ) wherein a and b are constants and are calculated by a=Z_{L}·exp((μ/(γ−μ))log(Z_{L}/Z_{N})) and b=(1/(μ−γ))log(Z_{L}/Z_{N}) where μ and γ are the smallest value and the largest value, respectively, of the values qₘ of the M optical flows calculated by the region-specific optical flow value calculation function and Z_{N} and Z_{L} are the closest distance and the farthest distance, respectively, of the distances from the M objects to the camera and are previously measured.

The process of extracting the optical flows using the moving images or the process of segmenting the image into the regions by applying the mean-shift method to the image is performed using a widely published, open-source library for computer vision called “OpenCV” (Open Source Computer Vision Library).

The optical flows extracted by the optical flow extractor or all pixel optical flow extractor are obtained as vectors. Accordingly, the values of the optical flows calculated by the optical flow value calculator or all pixel optical flow value calculator represent the absolute values of the vectors of the optical flows. For example, if a vector is (V1, V2), the value of the optical flow is calculated by obtaining the square root of the value of V1²+V2².

In the above moving image distance calculator, the optical flow value calculator may normalize the magnitudes of the M optical flows extracted by the optical flow extractor by calculating a sum of the magnitudes of the M optical flows and dividing the magnitude of each of the M optical flows by the sum and use the normalized magnitudes of the M optical flows as the values qₘ of the M optical flows.

In the above moving image distance calculator, the all pixel optical flow value calculator may normalize the magnitudes of the optical flows of all the pixels extracted by the all pixel optical flow extractor by calculating a sum of the magnitudes of the optical flows of all the pixels and dividing the magnitude of the optical flow of each of all the pixels by the sum and use the normalized magnitudes of the optical flows of all the pixels as the values of the optical flows of all the pixels.

In the above computer-readable storage medium storing the moving image distance calculation program, the optical flow value calculation function may cause the computer to normalize the magnitudes of the M optical flows extracted by the optical flow extraction function by calculating a sum of the magnitudes of the M optical flows and dividing the magnitude of each of the M optical flows by the sum and to use the normalized magnitudes of the M optical flows as the values qₘ of the M optical flows.

In the computer-readable storage medium storing the moving image distance calculation program, the all pixel optical flow value calculation function may cause the computer to normalize the magnitudes of the optical flows of all the pixels extracted by the all pixel optical flow extraction function by calculating a sum of the magnitudes of the optical flows of all the pixels and dividing the magnitude of the optical flow of each of all the pixels by the sum and to use the normalized magnitudes of the optical flows of all the pixels as the values of the optical flows of all the pixels.

In the moving image distance calculator, the M may be the number of all pixels of the image at time t of the moving images, and the distance calculator may calculate the distances Zₘ from the objects on all the pixels of the image at time t to the camera.

In the computer-readable storage medium storing the moving image distance calculation program, the M may be the number of all pixels of the image at time t of the moving images, and the distance calculation function may cause the computer to calculate the distances Zₘ from the objects on all the pixels of the image at time t to the camera.

### Advantageous Effects of Invention

The moving image distance calculator and the computer-readable storage medium storing the moving image distance calculation program according to the one embodiment are able to use the moving images of the objects captured by the camera to calculate the distances from the objects to the camera, regardless of the moving state or moving direction of the camera.

Also, the moving image distance calculator and the computer-readable storage medium storing the moving image distance calculation program are able to use the normalized magnitudes of the optical flows as the values qₘ (m=1, 2, . . . , M) of the optical flows to accurately calculate the distances from the objects to the camera.

### BRIEF DESCRIPTION OF DRAWINGS

FIG. 1 is a block diagram showing a schematic configuration of a moving image distance calculator according to an embodiment;

FIG. 2 is a flowchart showing a process in which the CPU of the moving image distance calculator according to the present embodiment calculates the distances to objects;

FIG. 3 is a drawing showing an image at time t of captured moving images of objects (persons);

FIG. 4 is a drawing showing a state in which the optical flows of all pixels have been extracted on the basis of the image shown in FIG. 3;

FIG. 5 is a drawing showing a state in which the image shown in FIG. 3 has been segmented into regions by applying the mean-shift method to the image;

FIG. 6 is a drawing in which the average of the values of optical flows in each of the regions segmented using the mean-shift method and the average direction of the optical flows are shown by the direction and length of a segment L extending from the center (white circle P) of the region;

FIG. 7 is a diagram showing a geometric model for explaining a method for obtaining the distances from objects to a camera on the basis of motion parallax;

FIG. 8 is a drawing three-dimensionally showing the state of the image shown in FIG. 3 from a different viewpoint;

FIG. 9 is a drawing three-dimensionally showing the state of a city on the basis of position information obtained from moving images captured from the sky;

FIG. 10 is a drawing three-dimensionally showing the state of objects in front of a traveling vehicle on the basis of distance information of the objects obtained using moving images of the objects captured by a camera; and

FIG. 11 is a drawing three-dimensionally showing the state of objects in a room on the basis of distance information obtained using moving images of the objects captured by a camera mounted on a robot that moves in the room.

### DESCRIPTION OF EMBODIMENTS

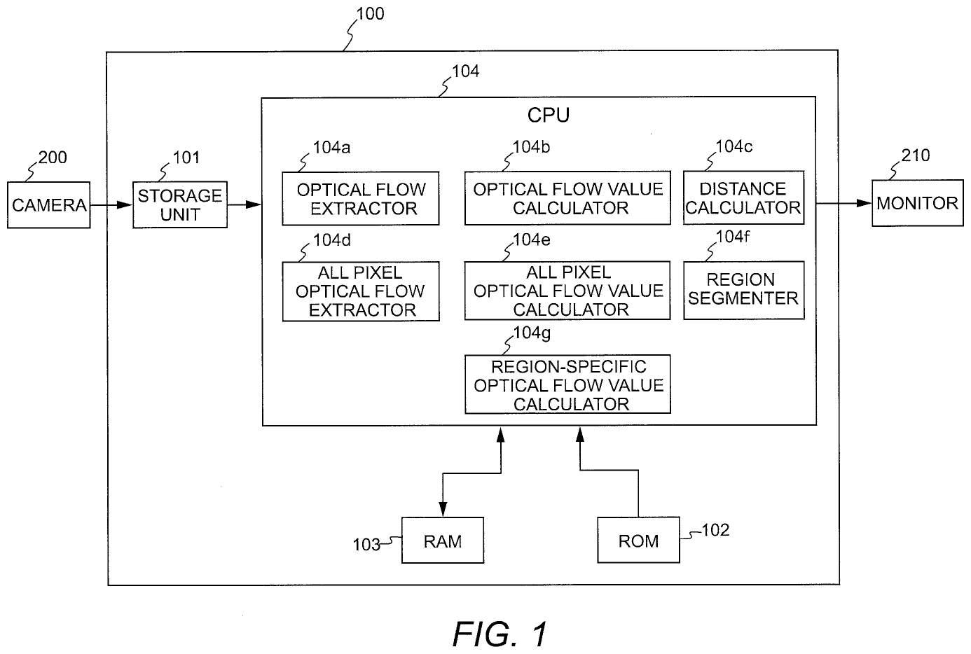

Now, a moving image distance calculator according to an embodiment of the present invention will be described in detail with reference to the drawings. FIG. 1 is a block diagram showing a schematic configuration of the moving image distance calculator. A moving image distance calculator 100 includes a storage unit 101, a ROM (read only memory: computer-readable storage medium) 102, a RAM (random-access memory) 103, and a CPU (central processing unit: computer, optical flow extractor, optical flow value calculator, distance calculator, all pixel optical flow extractor, all pixel optical flow value calculator, region segmenter, region-specific optical flow value calculator) 104.

A camera 200 is connected to the moving image distance calculator 100. The camera 200 is able to capture moving images of objects surrounding the camera. A camera can be mounted on, for example, a vehicle, airplane, drone, or the like.

The camera 200 includes a solid-state image sensor, such as a CCD image sensor or CMOS image sensor. Moving images captured by the camera 200 are stored in the storage unit 101. A monitor 210 is also connected to the moving image distance calculator 100.

Moving images captured by the camera 200 are stored in the storage unit 101. More specifically, the moving images captured by the camera 200 are stored in the storage unit 101 as digital data in which multiple frame images are stored in a time-series manner. For example, assume that moving images corresponding to a time T are captured by the camera 200. If the camera 200 is able to capture frame images at a rate of one frame image per time AT, T/AT frame images are stored in the storage unit 101 in a time-series manner.

The moving image distance calculator 100 or camera 200 may be provided with a frame buffer so that frame images captured by the camera 200 per unit time are temporarily stored in the frame buffer and the frame images stored in the frame buffer are stored in the storage unit 101 in a time-series manner. The moving images stored in the storage unit 101 need not be moving images captured by the camera 200 in real time and may be moving images previously captured by the camera 200 (past moving images).

Moving images used to calculate the distances from objects to the camera 200 are not limited to digital ones. For example, even analog moving images can be stored in the storage unit 101 as time-series frame images by going through a digital conversion process. Use of the frame images stored in a time-series manner allows the moving image distance calculator 100 to perform a distance calculation process.

The camera 200 may be of any type or may have any configuration as long as it is image capturing means capable of capturing moving images of the surrounding landscape or the like. For example, the camera 200 may be a typical movie camera, or a camera mounted on a mobile terminal, such as a smartphone.

The storage unit 101 consists of a typical hard disk or the like. Note that the configuration of the storage unit 101 need not be a hard disk and may be a flash memory, SSD (solid state drive/solid state disk), or the like. The storage unit 101 need not have a specific configuration as long as it is a storage medium capable of storing moving images as multiple time-series frame images.

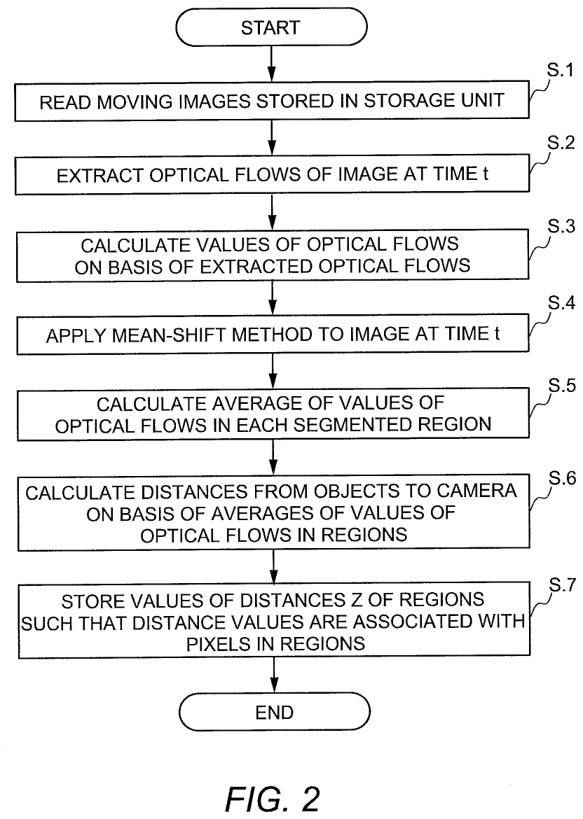

The CPU 104 calculates the distances from the objects in the frame images (moving images) to the camera 200 on the basis of the multiple frame images (moving images) stored in the storage unit 101 in a time-series manner. The CPU 104 performs a distance calculation process on the basis of a program (a program based on the flowchart of FIG. 2). Details thereof will be described later.

The ROM 102 is storing the program for calculating the distances from the camera 200 to the objects in the frame images, and the like. The RAM 103 is used as a work region when the CPU 104 performs processing.

In the moving image distance calculator 100 according to the present embodiment, the program (the program based on the flowchart of FIG. 2: moving image distance calculation program) is stored in the ROM 102. However, the storage medium (computer-readable storage medium) for storing the program is not limited to the ROM 102, and the program may be stored in the storage unit 101.

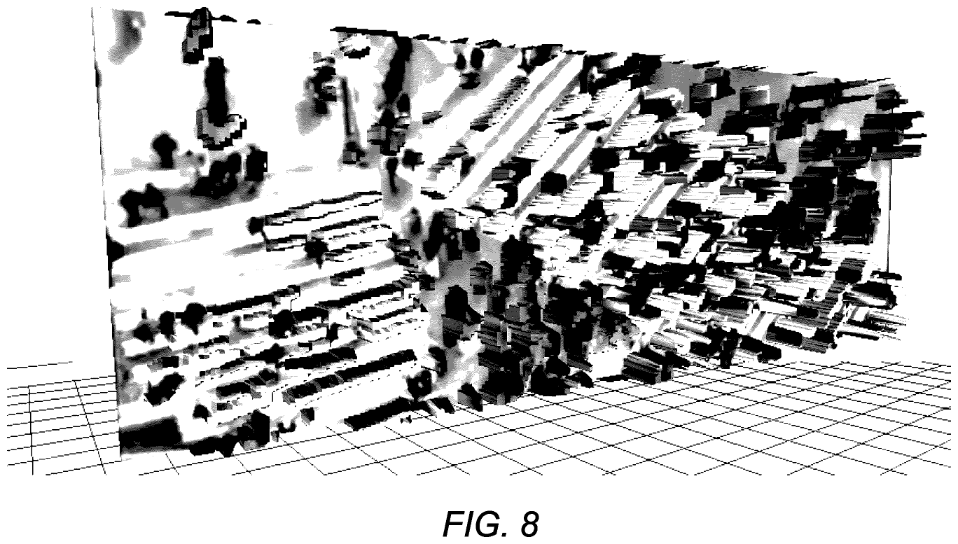

The monitor 210 displays the moving images captured by the camera 200, or images, moving images, or the like three-dimensionally converted in the distance calculation process (for example, images shown in FIGS. 8 to 11 (to be discussed later), etc.). For example, the monitor 210 is a typical display device, such as a liquid crystal display or CRT display.

Next, a method will be described by which the CPU 104 uses the moving images stored in the storage unit 101 (the frame images stored in a time-series manner) to calculate the distances from the objects in the moving images to the camera 200.

Euclid discussed a visual phenomenon called “motion parallax” 2000 or more years ago. Motion parallax is a visual phenomenon in which when objects are moving at an equal speed, the farther object appears to be moving to a lesser extent than the closer object, and is commonly observed. The AMP method and FMP method described above include calculating the distances from objects in moving images to a camera using motion parallax.

The moving image distance calculator 100 uses motion parallax and the moving images captured by the camera 200 to calculate the distances from the objects to the camera. On the other hand, the AMP method and FMP method include obtaining the value of motion parallax by setting the pixel of any coordinates in the moving images as a target pixel and calculating how the target pixel moves in the moving images.

The moving image distance calculator 100 uses a technology called “optical flow” as a method for calculating how objects in moving images have moved. Optical flows are the motions of objects in moving images (temporally continuous multiple frame images) and are represented by vectors.

Here, the target to which optical flow is applied has to be a two-dimensional scalar field at time t. A two-dimensional scalar field at time t is represented by f(x, y, t). In f(x, y, t), (x, y) represents coordinates in an image, and t represents the time. By representing a two-dimensional scalar field as f(x, y, t), ∂f/∂x, ∂f/∂y, which is the partial differential of x, y is calculated.

Optical flows are the motions of objects (coordinates) in moving images and therefore are represented by (dx/dt, dy/dt). In this case, the optical flows (dx/dt, dy/dt) are obtained from the following relational expression.

−∂f/∂t=(∂f/∂x)(dx/dt)+(∂f/∂y)(dy/dt)

To obtain the optical flows on the basis of this relational expression, partial differential of/at with respect to time t is used. To calculate the partial differential with respect to time t, the images to which optical flow is to be applied have to be continuous. For this reason, the moving images (temporally continuous multiple frame images) captured by the camera 200 are used as a scalar field including time t and coordinates (x, y) to which optical flow is applied, and the motions of the objects in the moving images are extracted as optical flows on a pixel-by-pixel basis.

Cases in which the objects move in the moving images include cases in which the objects themselves actively move in the moving images and cases in which the objects are passively moved in the moving images as the camera moves. Accordingly, the optical flows include the active motions of the objects and the passive motions of the objects resulting from the camera motion or the like and are extracted as vectors.

To extract the optical flows from the moving images, a library for computer vision can be used. Specifically, the optical flows can be extracted using a widely published, open-source library for computer vision called “OpenCV.”

FIG. 2 is a flowchart showing details of a process in which the CPU 104 of the moving image distance calculator 100 extracts the optical flows from the moving images and calculates the distances to the objects in the moving images. The CPU 104 reads the program stored in the ROM 102 and performs the process shown in FIG. 2 in accordance with the program. As described above, the moving images captured by the camera 200 are stored in the storage unit 101 on a frame image-by-frame image basis. The CPU 104 extracts optical flows at time t on the basis of the frame-based moving images stored in the storage unit 101.

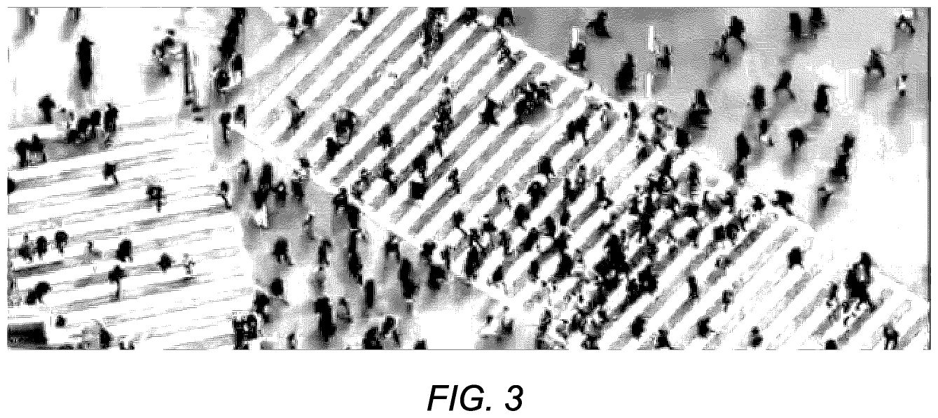

FIG. 3 shows a frame image at time t of the frame images captured by the camera 200 as an example. The image shown in FIG. 3 is an image showing the state of a scramble crossing captured from an upper part of a building. Each pixel of the image shown in FIG. 3 is provided with color information consisting of three colors, red, green, and blue (hereafter referred to as “RGB information”). An optical flow extraction algorithm assumes that “the brightness of objects does not vary among continuous frame images” and that “adjacent pixels move in a similar manner.” For this reason, the RGB information of each pixel is important information to extract an optical flow.

Since the optical flow extraction algorithm performs an extraction process on the basis of the scalar quantity, it is necessary to convert the three-dimensional RGB information of each pixel into one-dimensional information (one-dimensional value), which is the scalar quantity. When extracting optical flows using OpenCV, the three-dimensional RGB information is automatically converted into a scalar quantity in calculation of optical flows.

The optical flow of each pixel is extracted on the basis of the scalar quantity converted from the RGB information. For this reason, if adjacent pixels have similar RGB information (a group of such pixels is referred to as a “non-texture state”), it is difficult to extract the motions of the objects by optical flow. A portion corresponding to a non-texture state is often a portion that corresponds to asphalt (ground) or the like and in which no moving object exists.

Portions corresponding to a non-texture state, that is, portions from which optical flows are difficult to extract (portions in which optical flows are less likely to occur) are more likely to be segmented as the same region when subjected to an image region segmentation process using the mean-shift method (to be discussed later). In this region, the optical flows of pixels serving as the boundary of the region are more likely to be extracted more significantly than the optical flows of pixels inside the region. For this reason, the values of the optical flows (to be discussed later) of the boundary pixels tend to become larger than those of the pixels insides the region. The value of the optical flow of the entire region is complemented by the values of the optical flows of the boundary pixels.

If images of the state of the scramble crossing shown in FIG. 3 are captured by the camera 200, persons such as pedestrians moving on the crossing serve as main objects whose distances are to be calculated.

The CPU 104 reads the moving images stored in the storage unit 101 (S.1 in FIG. 2) and extracts optical flows of an image at time t on the basis of frame images (moving images) at times t−2 to t+2 (S.2 in FIG. 2). The CPU 104 extracts the optical flows of the image at time t from the moving images on the basis of the program (optical flow extraction function, all pixel optical flow extraction function) and therefore corresponds to an “optical flow extractor” 104a or “all pixel optical flow extractor” 104d (see FIG. 1).

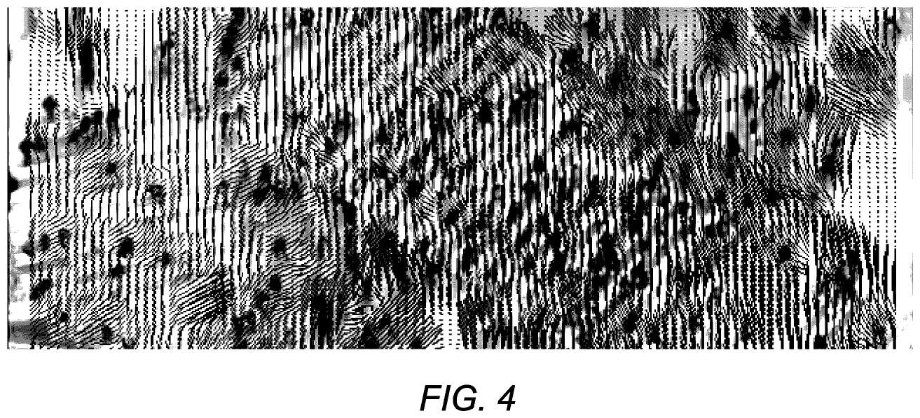

FIG. 4 shows an image in which the optical flows extracted at time t are superimposed on the image shown in FIG. 3.

While, in the present embodiment, the CPU 104 extracts the optical flows of the image at time t on the basis of the moving images at times t−2 to t+2, the moving images from which optical flows are to be extracted are not limited to the moving images at times t−2 to t+2. Also, the time length of the moving images from which optical flows are to be extracted is not limited to the time length from time t−2 to time t+2 and may be longer or shorter. For example, the data section (start time, end time) of the moving images or the length thereof may be changed in accordance with the features of the motions of the objects, or the like.

When extracting optical flows on the basis of moving images previously captured by the camera 200 (moving images captured in the past), the optical flows of an image at time t can be extracted on the basis of moving images at times t−2 to t+2. However, if time t at which the image has been captured by the camera 200 is considered as the current time, it is difficult to extract the optical flows at time t. The reason is that frame images (moving images) at times t+1 and t+2 have yet to be captured. In this case, for example, the optical flows of an image at time t−2 are extracted on the basis of moving images at times t−4 to t. Thus, the optical flows are extracted in a time-series manner without requiring batch processing while continuously capturing images using the camera 200.

As shown in FIG. 4, optical flows are extracted from the respective pixels of the moving images. While, each optical flow is shown by a segment in FIG. 4, an optical flow of each pixel extracted using the OpenCV library is obtained as a vector. In FIG. 4, the moving direction of an object on each pixel is shown by the direction of a segment, and the moving distance thereof is shown by the length of the segment. As shown in FIG. 4, the optical flows extracted from the respective pixels are oriented in various directions. It is determined that the objects have moved in various directions, on the basis of the directions of the optical flows.

Cases in which optical flows are extracted are not limited to cases in which objects alone move. Conceivable examples include cases in which the camera 200 moves in any direction, cases in which the objects alone move with the camera 200 being stationary, and cases in which both the camera 200 and objects move. When the camera 200 moves during image capture, moving images in which stationary objects appear to have moved all together with the motion of the camera 200 are stored (captured) and the optical flows of the respective stationary objects are extracted all together in accordance with the moving direction and moving distance of the camera. Thus, it is determined whether the camera 200 has moved, on the basis of the characteristics of the extracted optical flows. When the optical flows of stationary objects are extracted due to a motion of the camera, the distances from the camera 200 to the stationary objects are obtained using a method (to be discussed later) on the basis of the values of the extracted optical flows. On the other hand, when some objects alone move with the camera 200 being stationary, the optical flows of stationary objects are not extracted and the optical flows of the objects that have moved are extracted.

The CPU 104 then calculates the values of the optical flows representing the magnitudes of the optical flows on the basis of the extracted optical flows (S.3 in FIG. 2). The CPU 104 calculates the magnitudes of the optical flows as the values of the optical flows on the basis of the program (optical flow value calculation function, all pixel optical flow value calculation function) and therefore corresponds to an “optical flow value calculator” 104b or “all pixel optical flow value calculator” 104e (see FIG. 1).

Since the optical flows are represented by vectors, the values of the optical flows are calculated on the basis of the magnitudes of the vectors (the absolute values of the vectors). For example, assuming that the vector of an optical flow is (V1,V2), the value of the optical flow is calculated by obtaining the sum value (V1²+V2²) of the square value (VP) of V1 and the square value (V2²) of V2 and calculating the square root of the obtained sum value (V1²+V2²).

The CPU 104 of the moving image distance calculator 100 calculates the distances from the objects to the camera 200 by considering the calculated values of the optical flows as motion parallax. For this reason, the CPU 104 considers both of the calculated values of the optical flows of the stationary objects and the calculated values of the optical flows of the moving objects as motion parallax and determines that both are the same.

Even if both the camera 200 and the objects move, optical flows are extracted, whether the motions of the objects are larger than the motion of the camera 200 or the motion of the camera 200 is larger than the motions of the objects. Thus, the distances from the objects to the camera 200 are calculated by distance calculation using motion parallax (to be discussed later).

However, if the camera 200 and objects move in the same direction to the same extent, the optical flows of the objects are difficult to extract. Accordingly, with respect to the objects that have moved to the same extent in the same direction as that of the camera 200, the distances from the objects to the camera 200 are difficult to calculate. On the other hand, if objects are moving in a direction opposite to that of the camera 200, for example, if a user's vehicle having the camera 200 mounted thereon is moving forward and images of the state of an oncoming vehicle moving toward the user's vehicle are captured by the camera 200, the value of the optical flow of the oncoming vehicle is increased due to the speed of the user's vehicle and the speed of the oncoming vehicle being added up. Thus, the distance from the oncoming vehicle to the camera 200 is calculated as a shorter distance than the actual distance on the basis of the increased value of the optical flow.

In this case, the values of the optical flows of surrounding stationary objects are calculated, and a comparison is made between the calculated values of the optical flows of the surrounding objects and the value of the optical flow of the oncoming object. Thus, the oncoming vehicle or the like can be identified.

When the optical flows shown in FIG. 4 are viewed, it is found that not only the optical flows of moving objects, such as persons (pedestrians or the like), but also those of stationary objects have been extracted. Thus, it is determined that both the camera 200 and the objects (persons) are moving in the moving images at times t−2 to t+2. However, the persons are moving to a larger extent than the camera 200 in the moving images used to extract optical flows. For this reason, it is determined that the optical flows have occurred mainly from the motions of the persons.

Typically, when extracting optical flows from moving images, optical flows are extracted from moving images spanning an extremely short time. Accordingly, if the camera 200 is moved extremely greatly, that is, if the frame image capture range is changed greatly in an extremely short time, the motions of the objects become smaller than the motion of the camera 200. If the frame image capture range is not changed greatly, the motions of the objects become larger than the motion of the camera 200. Thus, it is determined that the optical flows extracted from the moving images have occurred due to the motions of the objects (persons).

While the CPU 104 according to the present embodiment extracts optical flows at time t on the basis of the moving images at times t−2 to t+2, the length (the interval from the start time to the end time) of the moving images may be set or changed arbitrarily as described above. By controlling the length of the moving images, the motions of the objects can be effectively extracted as optical flows.

If the display state of roads, the white lines of the roads, or the like in the moving images varies with the motion of the camera 200, the optical flows of the roads, white lines, or the like corresponding to the variation are extracted. The roads or the like often correspond to a non-texture state (in which adjacent pixels have similar RGB information) and therefore the calculated values of the optical flows tend to become relatively small. If the values of the optical flows are small, large (far) distances are calculated in a process of calculating the distances from the objects to the camera (to be discussed later). On the other hand, the calculated values of the optical flows of the actively moving objects, such as persons, tend to become larger than the calculated values of the optical flows of the roads or the like. When the values of the optical flows are larger, the distances from the objects to the camera become shorter (closer).

For this reason, a predetermined threshold is set on the distances from the objects to the camera 200, and it is determined whether the calculated distances are larger or smaller than the threshold. Thus, it is determined whether the extracted optical flows correspond to the motions of the objects, such as pedestrians, or correspond to the motions of the roads or the like resulting from the motion of the camera 200. However, it is difficult to uniformly extract all the objects, such as pedestrians, on the basis of only the magnitudes of the values of the optical flows or whether the distances are larger or smaller than the threshold. For this reason, it is preferred to flexibly set the threshold in accordance with the captured motions of the objects, the image capture range of the camera, or the like so that the object detection accuracy is increased.

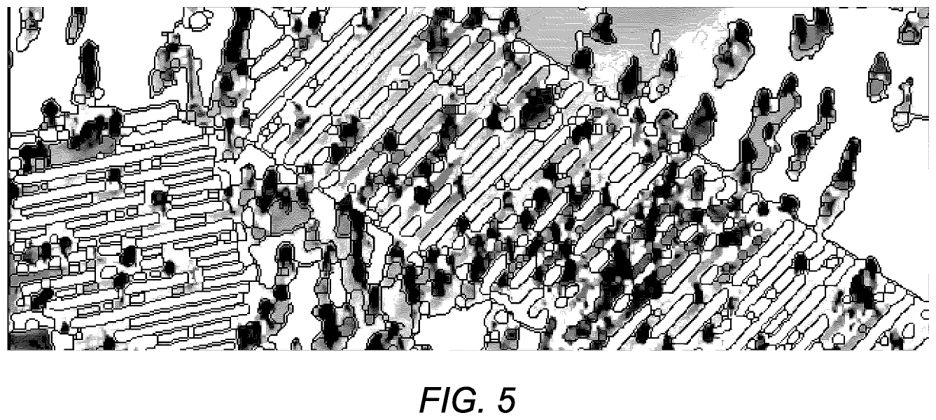

The CPU 104 of the moving image distance calculator 100 then segments the image at time t into regions by applying the mean-shift method to the image (S.4 in FIG. 2). The CPU 104 segments the image into regions corresponding to the objects on the basis of the program (region segmentation function) and therefore corresponds to a “region segmenter” 104f (see FIG. 1). FIG. 5 is a drawing showing a result obtained by applying the mean-shift method to the image at time t shown in FIG. 3.

The mean-shift method is known as one of the most predominant ones of the existing region segmentation techniques. The mean-shift method is a widely known region segmentation technique and is performed using a widely published, open-source library for computer vision called “OpenCV.” By applying the mean-shift method to the image (frame image) at time t, the image is segmented into regions in accordance with the presence or absence of objects or the like on the basis of the RGB values (color information) of each pixel of the image. Portions determined to be the same region among the segmented regions can be interpreted as being approximately equally distant from the camera.

In the mean-shift method, various parameters are set. By controlling the set values of the parameters, the sizes of the segmented regions are controlled. Also, by properly controlling the set values of the parameters, persons such as pedestrians are located in a one-segmented-region, one-person manner.

For example, if the number of the objects whose distances from the camera 200 are to be calculated is M (M≥3), the parameters may be properly controlled so that the image at time t is segmented into relatively small regions. Thus, the image at time t is segmented into K (K≥M) regions including regions corresponding to the M objects. Note that although the sizes of the segmented regions are increased or reduced by controlling the parameters, the number K of segmented regions depends on the image as a result. For this reason, even if the sizes of segmented regions and an increase or reduction in the number of segmented regions are controlled by controlling the parameters, it is difficult to control the parameters such that the number of segmented regions becomes a predetermined number.

The image to which the mean-shift method has been applied, shown in FIG. 5, shows a case in which segments indicating region boundaries have been formed so as to correspond to the respective pedestrians by properly controlling the parameters. Crosswalks and the like also have a texture. Accordingly, segments indicating region boundaries are formed so as to correspond to the while lines of the crosswalks. On the other hand, the asphalt portions of the crossing are a non-texture state. Accordingly, few segments indicating region boundaries are formed on the asphalt portions, and the asphalt portions are shown as relatively large regions.

The CPU 104 then obtains the values of optical flows in each of the regions segmented using the mean-shift method and calculates the average of the values of the optical flows (S.5 in FIG. 2). The CPU 104 calculates the average of the values of the optical flows in each segmented region on the basis of the program (region-specific optical flow value calculation function) and therefore corresponds to a “region-specific optical flow value calculator” 104g (see FIG. 1).

In the mean-shift method, the image is segmented into regions in accordance with the presence or absence of objects or the like on the basis of the RGB values (color information) of each pixel in the image, or the like. In particular, by properly controlling the parameters of the mean-shift method, the image is segmented into regions such that persons such as pedestrians are located in a one-segmented-region, one-person manner. Also, the values of optical flows of pedestrians or the like present in the segmented regions are normalized by obtaining the average of the optical flows in each segmented region.

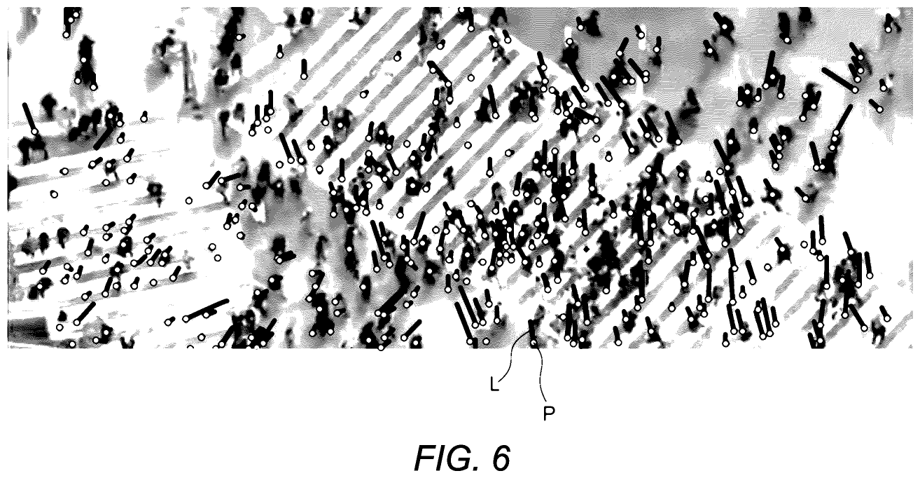

FIG. 6 is a drawing in which the average of the values of optical flows in each of the regions segmented using the mean-shift method is located in the center of the region. A while circle (o) P is shown in the central position (pixel) of each region, and the average direction of the optical flows and the average of the values of the optical flows are represented by the direction and length of a segment L extending from the white circle P. Note that the segments L or white circles P of the optical flows of portions corresponding to the ground are not shown in the image shown in FIG. 6.

As described above, the image shown in FIG. 3 shows a state in which both the camera 200 and the persons (objects) are moving. For this reason, as shown in FIG. 4, optical flows are extracted also from pixels corresponding to the roads due to the motion of the camera 200. However, differences occur between the distances from the camera 200 to the roads calculated on the basis of the optical flows extracted due to the motion of the camera 200 and the distances from the camera 200 to the persons calculated on the basis of optical flows extracted due to the motions of both the camera and persons. In the image at time t shown in FIG. 3, the persons are standing on the roads. Accordingly, the distances from the camera to the persons become shorter than the distances from the camera to the roads, that is, there occur differences in distance corresponding to the heights of the persons.

For this reason, objects having a predetermined height (distance) with respect to the roads are determined as persons. Thus, the roads and persons are distinguished from each other. By previously determining a threshold for determining such differences between the roads and persons, by an experiment or the like, the optical flows of the persons alone except for the roads are extracted. In FIG. 6, the average of the values of optical flows in each of regions determined to represent a person rather than a road among the regions segmented by the mean-shift method and the average direction of the optical flows are shown by a segment L extending from a white circle P located in the center of the region. In FIG. 6, the optical flows of multiple persons moving in various directions are extracted from the positions of those persons.

The CPU 104 then calculates the distances from the objects in the respective regions to the camera 200 on the basis of the averages of the values of the optical flows calculated for the respective regions (S.6 in FIG. 2). The CPU 104 calculates the distances from the objects to the camera using the values of the optical flows on the basis of the program (distance calculation function) and therefore corresponds to a “distance calculator” 104c (see FIG. 1).

The CPU 104 calculates the distances from the objects to the camera 200 by considering the values of the optical flows calculated for each region as motion parallax. Methods for calculating the distances from the objects to the camera 200 on the basis of motion parallax have been proposed in the AMP method and FMP method.

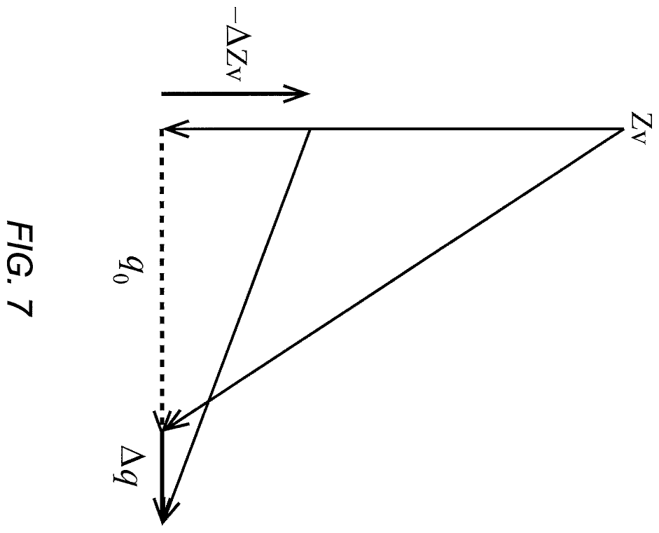

FIG. 7 is a diagram showing a geometric model for explaining a method for obtaining the distances from the objects to the camera 200 on the basis of motion parallax. The longitudinal axis of FIG. 7 represents the virtual distance Zv from an object to the camera 200. The positive direction of the virtual distance Zv is the downward direction of the diagram. The lateral axis of FIG. 7 represents motion parallax q. The motion parallax q is an experimental value of a pixel track obtained by optical flow, that is, the value of an optical flow. The positive direction of the motion parallax q is the rightward direction of the diagram.

The value of the virtual distance Zv is virtual and therefore it is assumed that the value corresponds to the value of parallax q₀, which is a coefficient of the motion parallax q determined ex post facto. Motion parallax is characterized in that as the value of motion parallax is larger, the distance from an object to the camera becomes shorter; as the value of motion parallax is smaller, the distance from an object to the camera becomes longer. Specifically, the virtual distance Zv is represented by a function Zv(q₀).

The optical flow of one pixel is extracted, and the value of the extracted optical flow is defined as q. It is assumed that the value q of the optical flow is (q₀+Δq) obtained by adding a small quantity Δq to the parallax q₀, which is a constant determined ex post facto, that is, it is assumed that q=q₀+Δq. It is also assumed that Zv corresponds to q₀ and a small quantity ΔZv of the virtual distance Zv corresponds to Δq. Assuming that the relationship between both is linear, the relationship becomes a relationship like a geometric model shown in FIG. 7 and the following linear proportional relationship holds.

Zv:q₀=−ΔZv:Δq

The following linear differential equation holds from this proportional relationship.

−q₀·ΔZv=ΔZv·Δq

This linear differential equation is solved as follows.

ΔZv/Zv=−Δq/q₀

log Zv=−q/q₀+c(c is a constant)

By deforming the above equations, the following equation holds.

Zv=a·exp(bq)

If a relationship of b=−1/q₀ is present and b is determined as a boundary condition, q₀ is determined ex post facto.

a and b (a>0, b<0) are indefinite coefficients. exp(bq) represents the bq-th power of the base value of a natural logarithm (Napier's constant). The values of the coefficients a and b are determined under individual boundary conditions. When the coefficients a and b are determined, the value of the motion parallax q is calculated on the basis of the moving images captured by the camera 200 and the value of Zv is obtained as the actual distance in the real world rather than a virtual distance.

The values of the constants a and b are determined on the basis of the variation ranges of the variables Zv and q. As described above, Zv represents the virtual distance from an object to the camera 200. The virtual distance is a value variable depending on the target world (the world serving as the target, the environment serving as the target) and is a value different from the actual distance in the real world. For this reason, the variation range of the actual distance in the real world corresponding to the virtual distance Zv in the three-dimensional space (target world) of the moving images is previously measured (determined) using a method, such as distance measurement using a laser (hereafter referred to as “laser measurement”) or visual observation. Thus, the actual distance in the real world is obtained from the corresponding distance in the target world. The method of calculating the virtual distance Zv using the value of motion parallax (the value of the optical flow) as described above means detecting a relative distance.

By associating the actual distance Z (the distance from an object to the camera) in the real world with the virtual distance Zv in the target world, the actual distance Z in the real world is obtained by the following Formula 1.

Z=a·exp(bq) Formula 1

That is, the distance Z from the object to the camera 200 in the real world is obtained as a distance function determined from a theory.

The moving image distance calculator 100 according to the present embodiment previously measures the variation range of the actual distance in the real world corresponding to the virtual distance Zv in the three-dimensional space (target world) of the moving images using, for example, laser measurement. The distance range of the virtual distance Zv measured by laser measurement is represented by Z_{N}≤Z_{V}≤Z_{L}. Z_{N} is equal to or less than Z_{L}.

More specifically, multiple objects, for example, M objects are seen in moving images. To calculate the distances (the actual distances in the real world) from the M objects to the camera 200, the distance (actual distance) to an object located in a position closest to the camera 200 of the M objects and the distance (actual distance) to an object located in a position farthest from the camera 200 thereof are previously measured by laser measurement. The distance to the object located in the location farthest from the camera 200 of the M objects is defined as Z_{L}, and the distance to the object located in the location closest to the camera 200 thereof is defined as Z_{N}. The distances (actual distances) from M−2 objects except for the object closest to the camera 200 and the object farthest from the camera 200 of the M objects to the camera are calculated on the basis of the values of the optical flows. Accordingly, to calculate the distances from the objects to the camera 200, it is preferable that the number of the objects be 3 or more (M−2>0).

The variation range of the value of the motion parallax q is determined by experimental values individually obtained from the moving images. That is, it is not necessary to previously perform measurement or the like. The variation range of the motion parallax q is obtained from the variation range of the values of the optical flows of multiple objects. The maximum to minimum range of the motion parallax q thus obtained is represented by μ≤q≤γ. That is, the minimum value of the values of the optical flows of the multiple objects corresponds to μ, and the maximum value thereof corresponds to γ. In other words, μ and γ are experimental values determined by the values of the multiple optical flows calculated on the basis of the moving images.

The correspondences between μ and γ and Z_{L} and Z_{N} are obtained on the basis of the nature of motion parallax. μ corresponds to Z_{L}, and γ corresponds to Z_{N}. This is due to the following nature of motion parallax: as the virtual distance Zv is farther, the amount of motion of an object point (object position) in moving images is reduced; as the virtual distance Zv is closer, the amount of motion of an object point (object position) in moving images is increased. As seen above, the shortest distance Z_{N} in the distance range of the virtual distance Zv corresponds to the maximum amount of motion γ in the variation range of the motion parallax q; the longest distance Z_{L} in the distance range of the virtual distance Zv corresponds to the minimum amount of motion μ in the variation range of the motion parallax q.

Accordingly, by substituting Z_{L} and μ and Z_{N} and γ into the values of Zv and q of Zv=a·exp(bq) in a corresponding manner, the following simultaneous equations with respect to a and b hold.

Z_{L}=a·exp(bμ) Formula 2

Z_{N}=a·exp(bγ) Formula 3

Formulas 2 and 3 correspond to the boundary conditions.

By solving these simultaneous equations, the constants a and b are obtained as follows.

a=Z_{L}·exp((μ(γ−μ))log(Z_{L}/Z_{N})) Formula 4

b=(1/(μ−γ))log(Z_{L}/Z_{N}) Formula 5

By applying the obtained constants a and b to the above Formula 1, the value of the virtual distance Zv is calculated as the actual distance Z in the real world.

The above actual distance Z is obtained for each segmented region. As described above, by properly setting the parameters of the mean-shift method, the image is segmented into regions, for example, such that persons such as pedestrians are located in a one-segmented region, one-person manner. That is, by properly setting the parameters of the mean-shift method, the image is segmented into K regions, whose number is larger than M, such that the M objects are located in different segmented regions. Accordingly, by setting the parameters of the mean-shift method such that the objects in the moving images are located in different regions, the distances Z from the camera 200 to the objects are obtained.

The CPU 104 then stores the values of the distances Z of the regions of the image at time t such that the distance values are associated with the pixels in the regions (S.7 in FIG. 2). That is, the CPU 104 attaches the value of the distance Z obtained for each region to each pixel of the image at time t. Thus, even if time t of the moving images is changed, the distance from the object to the camera 200 is instantaneously acquired for each pixel of an image at each time. Since distance information is stored so as to be associated with each pixel, information associated with each pixel of an image at each time is (r, g, b, D) consisting of color information and distance information D. This information is stored in the storage unit 101.

By storing the distance information D of each pixel of the moving images in the storage unit 101, the state of the objects in the moving images is three-dimensionally grasped using the distance information D. FIG. 8 is an image three-dimensionally showing the state of the scramble crossing shown in FIG. 3 from a different viewpoint. The image of FIG. 8 shows the state of the ground of the scramble crossing and the state of the persons from a different viewpoint. The position and height of each person in the image are those obtained by converting the average magnitude of the values of the optical flows placed in the center of each region into a distance.

The optical flow used as the motion parallax q in the geometrical model of FIG. 7 can take any direction, and the direction thereof is not limited. For example, three-dimensional distance information of a city may be acquired using moving images of the state of the city captured by the camera 200 mounted on a drone, airplane, or the like from the sky.

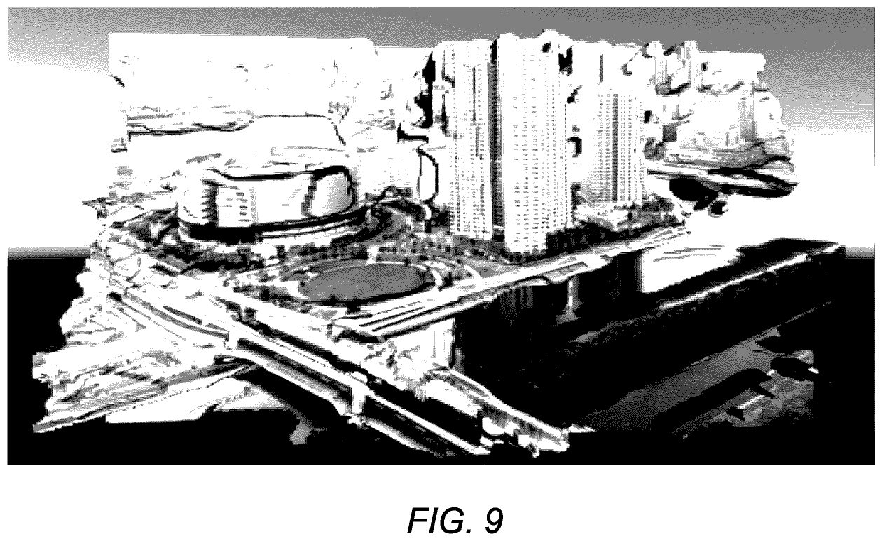

FIG. 9 is an image three-dimensionally showing the state of a city on the basis of position information of each pixel obtained using moving images captured from the sky. The camera 200 that captures moving images does not necessarily move in a horizontal direction with respect to buildings or the like in the city whose images are to be captured. Unlike the AMP method, the moving image distance calculator 100 according to the present embodiment does not need to move the camera 200 that captures images of objects, in the lateral direction to obtain distance information. Also, unlike the FMP method, it does not need to move the camera 200 only in the forward or rearward direction to obtain distance information. This reduces the restrictions on moving images used to calculate the distances to objects. Thus, the distances to the objects are obtained for each pixel using moving images captured by the camera 200 that moves in various directions.

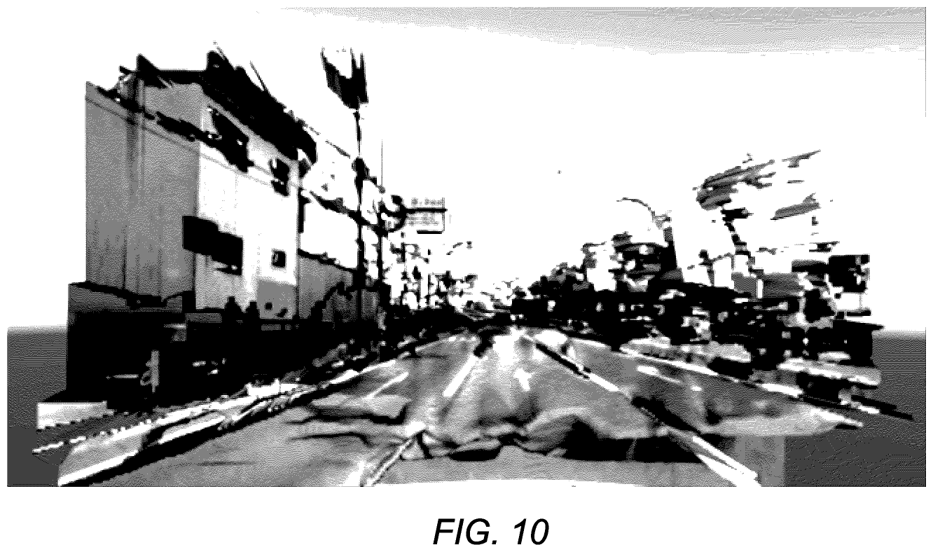

FIG. 10 shows an image three-dimensionally showing the state of the front of a traveling vehicle on the basis of distance information. This distance information is information obtained by capturing moving images of the front of the vehicle using the camera 200 and calculating the distances to objects in front of the vehicle for each pixel on the basis of the moving images. To measure the distances from objects to the camera 200 on the basis of moving images of the front of a traveling vehicle captured by the camera 200, the FMP method is conventionally used. As shown in FIG. 10, even if the distances from the objects to the camera 200 are calculated using optical flow on the basis of the moving images of the front of the vehicle captured by the camera 200, the three-dimensional image is generated with accuracy that is not different from that of a three-dimensional image generated by the FMP method.

As described above, the moving image distance calculator 100 does not have the restrictions on the moving direction of the camera, or the like, unlike the AMP method or FMP method and therefore is able to calculate the distances from the objects to the camera 200 on the basis of the moving images captured by the camera 200 that moves in various directions.

Thus, for example, the moving image distance calculator 100 is able to obtain the state of the space around a robot on the basis of moving images captured by a camera mounted on the robot. In the event of a disaster or the like, there is a need to cause a robot to enter a space that a person cannot easily enter and to determine the state of objects surrounding the robot on the basis of moving images captured by the camera of the robot. The camera of the robot need not necessarily capture moving images of the front in the travel direction of the robot or need not necessarily capture moving images in the lateral direction with respect to the travel direction of the robot. The camera is mounted on the head, chest, arm, or finger of the robot as necessary. The camera is moved in any direction in accordance with the motion of the robot and captures moving images. Even if the camera is moved in any direction, optical flows are extracted in accordance with the motion of the camera or in accordance with the motions of the objects whose images have been captured. Thus, the distances to the objects or the like (including the distances to walls, floors, or the like) are calculated on the basis of the extracted optical flows.

By controlling the chest, arm, finger, or the like of the robot on the basis of the calculated distances to the objects or the like, the robot is smoothly moved and more accurately controlled in the disaster site. Also, by three-dimensionally obtaining the distances to the objects surrounding the robot on the basis of the moving images captured by the camera 200, a three-dimensional map of the disaster site or the like is created, resulting in an increase in the mobility in subsequent rescue activities or the like.

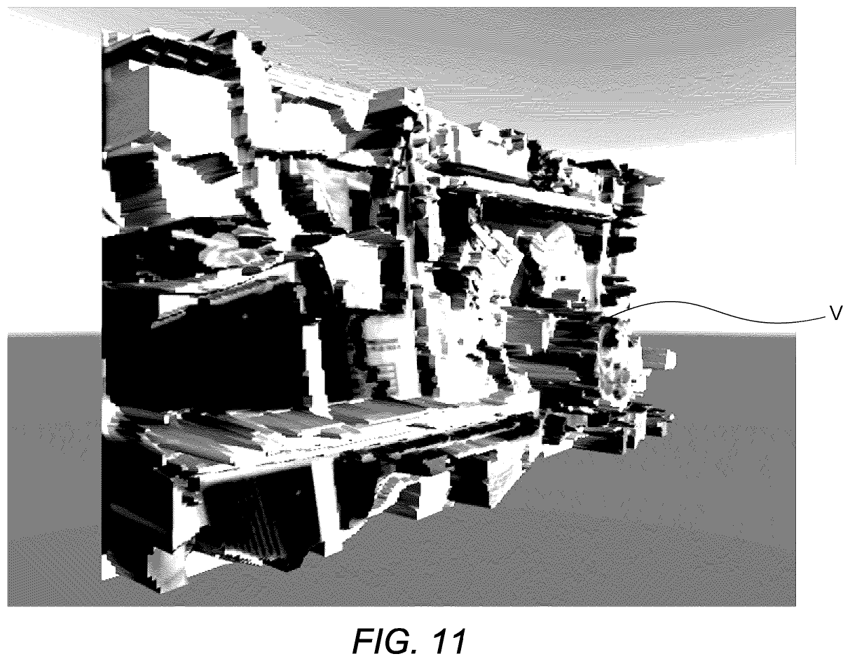

FIG. 11 is a drawing three-dimensionally showing the state of objects surrounding a robot moving in a room on the basis of distance information. This distance information is information obtained using moving images captured by a camera mounted on the robot. It is assumed that the robot is controlled so as to move to a valve V shown in FIG. 11 and then rotate the valve V with the arm and finger thereof. In this case, the robot does not necessarily continuously move. Accordingly, a time can occur during which the state of objects surrounding the robot makes no change in moving images captured by the camera.

As described above, optical flows are the motions of objects or the like in moving images and are represented by vectors. For this reason, if a state in which the moving images make no change is continued due to the absence of objects moving actively in the room and a stop of the motion of the robot, it would be difficult to extract optical flows and thus to calculate the distances to the objects surrounding the robot in the room. In this case, the distances to the surrounding objects calculated when the camera has moved most recently are continuously maintained with the camera not moving (with the moving images making no change), and the continuously maintained distance information is used subsequently when the camera is moved. Thus, the distances to the surrounding objects in the room are continuously determined.

When the camera moves, the camera does not necessarily move at a constant speed. For this reason, even if the distances from the objects to the camera are constant, the values of optical flows may be calculated as different values at each time.

Also, as described above, when calculating the distances from the objects to the camera 200, two dynamic ranges are required. That is, the dynamic range (μ, γ) of the values of optical flows and the dynamic range (Z_{N}, Z_{L}) of the distances to be obtained are required. While the dynamic range of the values of optical flows is calculated from moving images, the dynamic range of the distances has to be previously measured by visual observation or laser measurement. However, if the distances from the objects to the camera are long (the distance values are large), the dynamic range of the distances may not be surely accurately determined.

Also, with respect to the values of the optical flows calculated on the basis of the moving images, farther objects have smaller values than closer objects. The values of the optical flows vary not only with the motions of the objects but also with the motion of the camera.

For this reason, the CPU 104 normalizes and thus corrects the values of the optical flows so that the values of the optical flows do not become inaccurate when influenced by whether the distances from the objects to the camera are closer or farther or when influenced by the moving speed of the camera. Specifically, the CPU 104 normalizes the values of the optical flows by summing up the values of the optical flows of all pixels of an image at each time and dividing the value of the optical flow of each pixel of the image at the corresponding time by the sum.

Thus, even if the extracted optical flows vary among times due to variations in the moving speed or the like of the camera, or even if the optical flows are influenced by whether the distances to the objects are closer or farther, the distances from the objects to the camera are accurately calculated. This normalization method can be applied not only to the cases such as the inconstant moving speed of the camera, but also to various cases.

If the distance from an object to the camera is long (the distance value is large), the distance value of a pixel corresponding to the distant object is calculated by obtaining CZ(q) by multiplying the calculated distance Z(q) by a coefficient C. The coefficient C can be determined using any method, such as GPS.

Any apparatus can serve as the moving image distance calculator 100 according to the present embodiment as long as it includes a camera for capturing moving images of objects and a CPU for calculating the distances to objects using moving images.

Recent mobile terminals, such as smartphones, are typically provided with a camera and are able to capture moving images. Thus, the camera of a mobile phone may be used to capture moving images of objects, and the CPU of the mobile phone may be used to extract optical flows at each time using the captured moving images and to calculate the distances from the objects to the mobile phone. Also, a three-dimensional image may be generated on the basis of the captured moving images.

Recently, a method called ToF (time of flight) has been proposed as a method for generating a three-dimensional image. ToF includes projecting light onto an object, receiving reflected light of the light, measuring the time from the projection of the light to the reception of the reflected light, and calculating the distance to the object on the basis of the measured time. To generate a three-dimensional image using ToF, an object must be a diffuse reflection object. Accordingly, ToF is disadvantageous in that its measurement accuracy with respect to specular reflection objects, such as hardware objects or china objects, is low. ToF also requires an environment in which any substance that blocks travel of light, such as rain or smoke, is not present between the camera and objects. ToF also has a problem that the range of the distances to objects whose three-dimensional image can actually be generated using ToF is about 50 cm to about 4 m, that is, there is a limit to the application range of ToF. Also, the correspondences between the distances to the objects to be measured and the pixels of the camera are not sufficiently accurate, and improvements are continuously being made to improve the performance of hardware for implementing these functions.

On the other hand, to obtain the distances to objects by extracting optical flows on the basis of moving images of the objects captured by a camera, as is done by the moving image distance calculator 100 according to the present embodiment, it is only necessary to include a typical camera and a CPU or the like capable of extracting optical flows. For this reason, even a typical smartphone or the like is able to accurately calculate the distances to the objects.

Specifically, when capturing moving images using a mobile phone, such as a smartphone, by shaking the mobile phone slightly, optical flows based on the motion of the mobile phone are extracted from the moving images. By extracting optical flows from several frame images captured at the moment when the mobile phone has been shaken, a three-dimensional image is generated. Also, by capturing moving images of moving objects with the mobile phone kept stationary, a three-dimensional image is generated on the basis of the optical flows of the moving objects. Thus, the distances from not only close objects but also far objects and moving objects to the camera are calculated, and a three-dimensional image is generated.

While the moving image distance calculator 100 has been described in detail as one embodiment of the moving image distance calculator and the computer-readable storage medium storing a moving image distance calculation program according to the present invention, the moving image distance calculator and the computer-readable storage medium storing a moving image distance calculation program according to the present invention are not limited to the embodiment.

For example, while, in the above embodiment, the CPU 104 of the moving image distance calculator 100 segments the image at time t into regions using the mean-shift method and calculates the distances from the objects to the camera 200 by obtaining the average of the values of the optical flows of all pixels in each region, the mean-shift method need not necessarily be used to calculate the distances from the objects in the image at time t to the camera 200.

For example, the distance of each pixel may be calculated by obtaining the value of the optical flow of each pixel without using the mean-shift method. Specifically, by obtaining the sum of the values of the optical flows of all pixels of the image at time t and dividing the value of the optical flow of each pixel by the sum as described above, the value of the optical flow of each pixel is obtained such that correction is made with respect to close distances or far distances or with respect to the moving speed of the camera. Thus, even if the mean-shift method is not used, the distance of each pixel is accurately calculated.

If the mean-shift method is not applied to the image at time t, the value of an optical flow calculated from a portion in a non-texture state, such as a road, is an extremely small value or zero. Similarly, if the mean-shift method is applied, the average of the values of optical flows calculated from a portion in a non-texture state is extremely small. For this reason, the distances of regions that are segmented using the mean-shift method and whose calculated optical flow value averages are small may be calculated as farther distances than the actual distances. In this case, correction is made by interpolating the calculated distances of the regions whose optical flow values are small by the calculated distances of regions that surround those regions and whose optical flow values are not small.

In the above embodiment, the number of objects in the image at time t is, for example, M, and the CPU 104 of the moving image distance calculator 100 extracts the M optical flows corresponding to the M objects and calculates the distances to the M objects. Here, the M objects only have to include objects having the closest distance Z_{N} and the farthest distance Z_{L}, respectively, previously measured by visual observation or laser measurement and another object whose distance is to be measured, that is, M only has to be equal to or greater than three. For this reason, the number of objects whose distances from the camera are to be calculated is not limited to a particular number as long as the number is equal to or greater than three.

The objects only have to be seen on the image at time t and therefore all pixels of the image at time t may correspond to the objects. That is, the number M of objects may be the number of all pixels. By calculating the distances from the objects corresponding to all the pixels to the camera, distance information of all the pixels is obtained. Also, if all the pixels of the image at time t correspond to the objects, there is no need to segment the image at time t into regions corresponding to the M objects using the mean-shift method.

The number M of objects may be a fraction of the number of all the pixels rather than the number of all the pixels. For example, a region consisting of 2 vertical pixels×2 horizontal pixels, that is, a total of four pixels is set as one region, and one pixel is set as an object in each region. Thus, with respect to one pixel per four pixels, the distance from the camera to the pixel is calculated. By calculating the distances at a rate of one pixel per several pixels rather than calculating the distances of all the pixels, the CPU 104 is able to reduce the processing load thereof and to speed up processing.

### REFERENCE SIGNS LIST

100 moving image distance calculator
101 storage unit
102 ROM (computer-readable storage medium)
103 RAM
104 CPU (computer, optical flow extractor, optical flow value calculator, distance calculator, all pixel optical flow extractor, all pixel optical flow value calculator, region segmenter, region-specific optical flow value calculator)
200 camera
210 monitor
V valve
L segment (showing average of values of optical flows in regions)
P white circle (showing center of segmented regions)

1. A moving image distance calculator comprising:
an optical flow extractor configured to use moving images of M objects captured by a camera to extract M optical flows from pixels corresponding to the M objects in an image at time t of the moving images, M being equal to or greater than 3;
an optical flow value calculator configured to calculate magnitudes of the M optical flows extracted by the optical flow extractor as values qₘ of the M optical flows, m being an integer of 1 to M; and
a distance calculator configured to calculate distances Zₘ from the M objects to the camera by the formula, m being an integer of 1 to M:
Zₘ=a·exp(bqₘ)
wherein a and b are constants and are calculated by a=Z_{L}·exp((μ/(γ−μ)log(Z_{L}/Z_{N})) and b=(1/(μ−γ))log(Z_{L}/Z_{N}) where μ and γ are the smallest value and the largest value, respectively, of the values qₘ of the M optical flows calculated by the optical flow value calculator and Z_{N} and Z_{L} are the closest distance and the farthest distance, respectively, of the distances from the M objects to the camera and are previously measured.

2. The moving image distance calculator according to claim 1, wherein
the optical flow value calculator normalizes the magnitudes of the M optical flows extracted by the optical flow extractor by calculating a sum of the magnitudes of the M optical flows and dividing the magnitude of each of the M optical flows by the sum and uses the normalized magnitudes of the M optical flows as the values qₘ of the M optical flows.

3. The moving image distance calculator according to claim 1 or 2, wherein
the M is the number of all pixels of the image at time t of the moving images, and
the distance calculator calculates the distances Zₘ from the objects on all the pixels of the image at time t to the camera.

4. A moving image distance calculator comprising:
an all pixel optical flow extractor configured to use moving images of M objects captured by a camera to extract optical flows of all pixels of an image at time t of the moving images, M being equal to or greater than 3;
an all pixel optical flow value calculator configured to calculate magnitudes of the optical flows of all the pixels extracted by the all pixel optical flow extractor as values of the optical flows of all the pixels;
a region segmenter configured to segment the image at time t into K regions by applying a mean-shift method to the image at time t, K being equal to or greater than M;
a region-specific optical flow value calculator configured to calculate values qₘ of optical flows corresponding to the M objects by extracting M regions including pixels of the image at time t on which the objects are seen, from the K regions segmented by the region segmenter and obtaining an average of values of optical flows of all pixels in each of the M regions, m being an integer of 1 to M; and
a distance calculator configured to calculate distances Zₘ from the M objects to the camera by the formula, m being an integer of 1 to M:
Zₘ=a·exp(bqₘ)
wherein a and b are constants and are calculated by a=Z_{L}·exp((μ/(γ−μ))log(Z_{L}/Z_{N})) and b=(1/(μ−γ))log(Z_{L}/Z_{N}) where μ and γ are the smallest value and the largest value, respectively, of the values qₘ of the M optical flows calculated by the region-specific optical flow value calculator and Z_{N} and Z_{L} are the closest distance and the farthest distance, respectively, of the distances from the M objects to the camera and are previously measured.

5. The moving image distance calculator according to claim 4, wherein
the all pixel optical flow value calculator normalizes the magnitudes of the optical flows of all the pixels extracted by the all pixel optical flow extractor by calculating a sum of the magnitudes of the optical flows of all the pixels and dividing the magnitude of the optical flow of each of all the pixels by the sum and uses the normalized magnitudes of the optical flows of all the pixels as the values of the optical flows of all the pixels.

6. A computer-readable storage medium storing a moving image distance calculation program of a moving image distance calculator that uses moving images of M objects captured by a camera to calculate distances from the M objects in the moving images to the camera, M being equal to or greater than 3, the moving image distance calculation program causing a computer to perform:
an optical flow extraction function of extracting M optical flows from pixels corresponding to the M objects in an image at time t of the moving images;
an optical flow value calculation function of calculating magnitudes of the M optical flows extracted by the optical flow extraction function as values qₘ of the M optical flows, m being an integer of 1 to M; and
a distance calculation function of calculating distances Zₘ from the M objects to the camera by the formula, m being an integer of 1 to M:
Zₘ=a·exp(bqₘ)
wherein a and b are constants and are calculated by a=Z_{L}·exp((μ/(γ−μ))log(Z_{L}/Z_{N})) and b=(1/(μ−γ))log(Z_{L}/Z_{N}) where μ and γ are the smallest value and the largest value, respectively, of the values qₘ of the M optical flows calculated by the optical flow value calculation function and Z_{N} and Z_{L} are the closest distance and the farthest distance, respectively, of the distances from the M objects to the camera and are previously measured.

7. The computer-readable storage medium storing the moving image distance calculation program according to claim 6, wherein
the optical flow value calculation function causes the computer to normalize the magnitudes of the M optical flows extracted by the optical flow extraction function by calculating a sum of the magnitudes of the M optical flows and dividing the magnitude of each of the M optical flows by the sum and to use the normalized magnitudes of the M optical flows as the values qₘ of the M optical flows.

8. The computer-readable storage medium storing the moving image distance calculation program according to claim 6 or 7, wherein
the M is the number of all pixels of the image at time t of the moving images, and
the distance calculation function causes the computer to calculate the distances Zₘ from the objects on all the pixels of the image at time t to the camera.

9. A computer-readable storage medium storing a moving image distance calculation program of a moving image distance calculator that uses moving images of M objects captured by a camera to calculate distances from the M objects in the moving images to the camera, M being equal to or greater than 3, the moving image distance calculation program causing a computer to perform:
an all pixel optical flow extraction function of extracting optical flows of all pixels of an image at time t of the moving images;
an all pixel optical flow value calculation function of calculating magnitudes of the optical flows of all the pixels extracted by the all pixel optical flow extraction function as values of the optical flows of all the pixels;
a region segmentation function of segmenting the image at time t into K regions by applying a mean-shift method to the image at time t, K being equal to or greater than M;
a region-specific optical flow value calculation function of calculating values qₘ of optical flows corresponding to the M objects by extracting M regions including pixels of the image at time t on which the objects are seen, from the K regions segmented by the region segmentation function and obtaining an average of values of optical flows of all pixels in each of the M regions, m being an integer of 1 to M; and
a distance calculation function of calculating distances Zₘ from the M objects to the camera by the formula, m being an integer of 1 to M:
Zₘ=a·exp(bqₘ)
wherein a and b are constants and are calculated by a=Z_{L}·exp((μ/(γ−μ))log(Z_{L}/Z_{N})) and b=(1/(μ−γ))log(Z_{L}/Z_{N}) where μ and γ are the smallest value and the largest value, respectively, of the values qₘ of the M optical flows calculated by the region-specific optical flow value calculation function and Z_{N} and Z_{L} are the closest distance and the farthest distance, respectively, of the distances from the M objects to the camera and are previously measured.

10. The computer-readable storage medium storing the moving image distance calculation program according to claim 9, wherein
the all pixel optical flow value calculation function causes the computer to normalize the magnitudes of the optical flows of all the pixels extracted by the all pixel optical flow extraction function by calculating a sum of the magnitudes of the optical flows of all the pixels and dividing the magnitude of the optical flow of each of all the pixels by the sum and to use the normalized magnitudes of the optical flows of all the pixels as the values of the optical flows of all the pixels.
